(19) United States
(12) Patent Application Publication
(10) Pub. No.: US 2024/0092490 A1
(43) Pub. Date: Mar. 21, 2024

(54) A CANOPY YOKE ATTACHMENT

(71) Applicant: ANIMAL DYNAMICS LIMITED, Oxford, Oxfordshire (GB)

(72) Inventors: Anthony CHILD, Oxford (GB); Adrian THOMAS, Oxford (GB)

(73) Assignee: ANIMAL DYNAMICS LIMITED, Oxford, Oxfordshire (GB)

(21) Appl. No.: 18/273,513

(22) PCT Filed: Jan. 20, 2022
(86) PCT No.: PCT/GB2022/050154

§ 371 Date: Jul. 20, 2023

(30) Foreign Application Priority Data
Jan. 20, 2021 (GB) 2100741.4

(51) Int. Cl. B64D 17/24; B64C 31/036; B64D 17/02; B64D 17/34

(52) U.S. Cl. CPC B64D 17/24; B64C 31/036; B64D 17/025; B64D 17/34

(57) ABSTRACT

A canopy attachment yoke, comprising: first and second support bars, each having a first end and a second end, wherein the respective first ends are configured for attachment to at least one support line of a canopy and the respective second ends are configured for attachment to a vehicle; and at least one spreader bar having a first end and a second end, the first end of the spreader bar connected to the first support bar and the second end of the spreader bar connected to the second support bar, wherein the spreader bar is slidably mounted on the first and second support bars.

The present invention relates to a canopy attachment yoke. More specifically, the present invention relates to a canopy arrangement comprising the yoke, and an aerial vehicle including the canopy arrangement.

### BACKGROUND OF THE INVENTION

Powered air vehicles using soft wings made of fabric (e.g. a canopy/parachute), generally known as powered parachutes, are used for leisure activities and surveillance, and occasionally for air delivery. Such vehicles may also be referred to as motorised parachutes, paraplanes or PPCs, paramotor, powered paragliders or PPGs.

The low cost and high lift capability of these vehicles make them particularly suitable as delivery vehicles and their capability can be significantly enhanced by designing them to fly autonomously using a control and guidance system following a set of predetermined instructions and/or directed by a remote pilot.

The most significant challenge for users operating an autonomous aerial vehicle may occur when the vehicle is preparing for take-off. During take-off, the wing needs first to inflate and then to sit stably above the vehicle to ensure a successful and safe take-off.

To further explain the factors affecting such vehicles, an aerial vehicle 1 is shown schematically in FIG. 1. The aerial vehicle 1 comprises an airframe 2 (e.g. chassis) comprising an undercarriage 3. In the arrangement shown, the undercarriage 3 comprises three wheels 4 provided in a tricycle arrangement.

Other forms of undercarriage 3, not necessarily including wheels 4, are also possible. The centre of gravity 5 of the aerial vehicle 1 is preferably arranged within the footprint of the undercarriage 3 such that the aerial vehicle 1 is stably supported by the undercarriage 3 when at rest. The aerial vehicle 1 further comprises a source of thrust 6. In the arrangement shown, the source of thrust 6 comprises an engine (not shown) and propeller 7. The propeller 7 is mounted on a hub 8. A guard arrangement 9 may be provided around the propeller 7 and/or engine to prevent injury to users and/or anything impacting the propeller 7 and/or engine, such as canopy support and/or control lines. The aerial vehicle 1 may further comprise a payload bay 100.

The aerial vehicle 1 further comprises a canopy (not shown) which can be of conventional construction. A plurality of canopy lines 11 are secured between various points on the canopy and the airframe 2 of the aerial vehicle 1. In FIG. 1, only a single canopy line 11 is shown, to aid the illustration and to generally indicate the direction of the net force which is imparted by the canopy on the airframe 2 of the aerial vehicle 1 in use. Any reference to a ‘canopy line’ herein may be seen as a reference to the canopy lines collectively, as appropriate.

The canopy lines 11 are secured to at least one securement point 12 on the aerial vehicle 1. The canopy can effectively pivot about the at least one securement point 12 on the chassis 2. So as to provide a stable aerial vehicle 1, there may be two securement points 12 separated from one another in a direction perpendicular to the longitudinal axis of the aerial vehicle 1. Half of the canopy lines 11 may be secured to a first securement point 12 and the other half of the canopy lines 11 may be secured to a second securement point 12. The canopy may further comprise control lines (not shown), secured to other control mechanisms of the aerial vehicle 1. Any suitable number of securement points 12 may be used. There may be one securement point 12, or more than two securement points 12 provided, which may be arranged linearly or otherwise. Multiple securement points may be provided, distributed across two axes (e.g. a plane). Any other conventional features of a powered parachute arrangement may be adopted with the arrangements disclosed herein, as appropriate.

A powered parachute is similar to a paramotor, in that it combines an inflatable canopy with a source of thrust. Whereas a powered parachute provides an airframe having an undercarriage and an optional seat for a user, a paramotor comprises an airframe which is secured directly to a user's back. Nevertheless, the principles of use are the same and the skilled person will appreciate that the arrangements described herein may be applicable to paramotors as well as to powered parachutes. The term ‘aerial vehicle’ is used herein to encompass all such arrangements.

As indicated in FIG. 1 by the dotted line, the source of thrust 6 provides a thrust which has a line of thrust 15. The line of thrust 15 is substantially perpendicular to the plane in which the propeller 7 rotates. In the arrangement shown in FIG. 1, the line of thrust 15 is substantially parallel to the longitudinal axis of the aerial vehicle 1 and generally horizontal. However, the angle of the line of thrust 15 relative to the longitudinal axis of the vehicle 1 and/or horizontal may not be parallel and/or may be adjustable. The source of thrust 15 propels the vehicle 1 forwards.

Prior to take-off, the canopy must first be inflated and rotated into a position substantially above the vehicle 1 so as to create lift. As the vehicle 1 is propelled forward by the source of thrust 6, the flow of air over the canopy creates lift and causes the vehicle 1 to become airborne.

Initially, the uninflated canopy is laid out behind the aerial vehicle 1, so as to be generally aligned with the longitudinal axis of the aerial vehicle 1. As the source of thrust 6 is initiated, the wash from the source of thrust 6 causes the canopy to begin to inflate, and for the at least one canopy line 11 securing the canopy to the aerial vehicle 1 to become taut. As the aerial vehicle 1 begins to move forwards and as the source of thrust 6 generates a wash over the wing, the wing experiences an airflow that causes it to inflate and experience aerodynamic forces such as lift and drag. As the canopy is further inflated and creates a pressurised wing, the canopy starts to rise towards a position where it is generally over the aerial vehicle 1. The phase during which the canopy rises from the ground to being generally above the vehicle 1 may be referred to as the “rotation” phase.

During the inflation of the canopy and the initial phase of the rotation, the canopy lines 11 are in the vicinity of the propeller 7 and may become tangled and/or caught on the propeller 7. Even if there is a guard arrangement 9, the canopy lines 11 may snag on the airframe 2, propeller 7 and/or guard arrangement 9, preventing the correct inflation and/or rotation of the canopy.

There is a desire to ensure that the inflation and rotation of the canopy can be reliably and repeatedly performed. At least some of the initiation, set up and configuration of the vehicle may need to be automated, with little or no human intervention. If the vehicle is being remotely controlled, any tangling and/or snagging of the canopy lines on the vehicle may render the vehicle unusable and cause the mission to be aborted.

Generally, the canopy lines may be classified as either support (i.e. structural) lines and control lines. There may be many support lines, each secured between a point on the canopy and a securement point on the vehicle. The support lines may be attached to the canopy in a matrix pattern, distributed across the underside of the canopy. Generally, the canopy securement points may be arranged in rows, e.g. three rows A, B and C. The ‘A’ securement points may be distributed across the leading edge of the canopy. The ‘C’ securement points may be towards the trailing edge of the canopy.

The control lines may affect the wing control surfaces, and may comprise accelerator and/or brake lines. There may be more than one accelerator line and more than one brake line. There may be an accelerator line and brake line on the port side of the canopy, and an accelerator line and brake line on the starboard side of the canopy. The accelerator and brake lines may be independently operable.

During unpacking, packing and/or use of the canopy, some or all of the canopy lines may become tangled. Any tangled lines are dangerous, as it may prevent the correct operation of the canopy. Even a single tangled canopy line can drastically affect the operation of the canopy. There is a desire to reduce the chances of lines tangling as much as possible.

During assembly and disassembly of the canopy, the various canopy lines need to be attached to/detached from the vehicle. It is important that the support lines are secured to the correct locations, and the brake and acceleration lines are positioned so as to allow a pilot to access them in flight.

If care is not taken, a user may secure canopy lines to the wrong securement points, or not secure some canopy lines at all.

The applicant has previously disclosed an aerial vehicle including a canopy attachment arrangement, in GB2579186.

The present invention seeks to address at least one of the aforementioned problems.

### SUMMARY OF THE INVENTION

Accordingly, the present invention provides a canopy attachment yoke, comprising:
first and second support bars, each having a first end and a second end, wherein the respective first ends are configured for attachment to at least one support line of a canopy and the respective second ends are configured for attachment to a vehicle; and
at least one spreader bar having a first end and a second end, the first end of the spreader bar connected to the first support bar and the second end of the spreader bar connected to the second support bar.

In at least one embodiment, the first and second support bars and the at least one spreader bar are substantially rigid.

In at least one embodiment, the at least one spreader bar is rigidly secured between the first and second support bars.

In at least one embodiment, the canopy attachment yoke comprises a single spreader bar, wherein the first end of the spreader bar is connected at a point between the first and second ends of the first support bar and the second end of the spreader bar is connected at a point between the first and second ends of the second support bar.

In at least one embodiment, the spreader bar is slidably mounted on the first and second support bars.

In at least one embodiment, the first and second support bars further comprise at least one eyelet for receiving a respective control line of the canopy therethrough, in use.

In at least one embodiment, the first and second support bars further comprise at least one anchor point for securement of the end of a respective control line of the canopy, in use.

In at least one embodiment, there is provided a canopy arrangement comprising:
a canopy, comprising a plurality of support lines and at least one control line; and
a canopy attachment yoke according to the invention, connected to the support lines of the canopy.

In at least one embodiment, the canopy attachment yoke comprises at least one eyelet at or adjacent the first end of each support bar, and an anchor point at or adjacent the second end of each support bar,
wherein the at least one control line is fed through said eyelet and secured to said anchor point.

In at least one embodiment, the canopy arrangement further comprises an actuator mechanism operably connected to the control line at a point between the anchor point and the eyelet, wherein operation of the actuator mechanism causes the control line to travel through the eyelet.

In at least one embodiment, the actuator mechanism comprises a servomechanism and an actuator line secured between the servomechanism and the control line.

In at least one embodiment, there is provided an aerial vehicle comprising:
an airframe; and
a canopy arrangement according to the invention, wherein the canopy attachment yoke is removably attached to the airframe.

### BRIEF DESCRIPTION OF THE DRAWINGS

Embodiments of the present invention will now be described, by way of non-limiting example only, with reference to the figures in which:

FIG. 1 illustrates an aerial vehicle with which a canopy attachment yoke embodying the present invention may be used; and

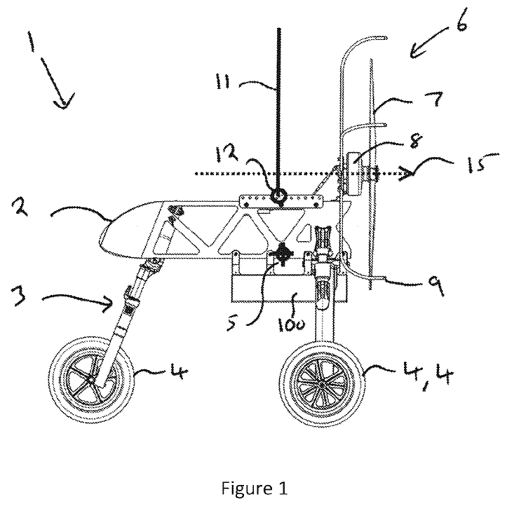

FIG. 2 illustrates a canopy attachment yoke embodying the present invention.

### DETAILED DESCRIPTION

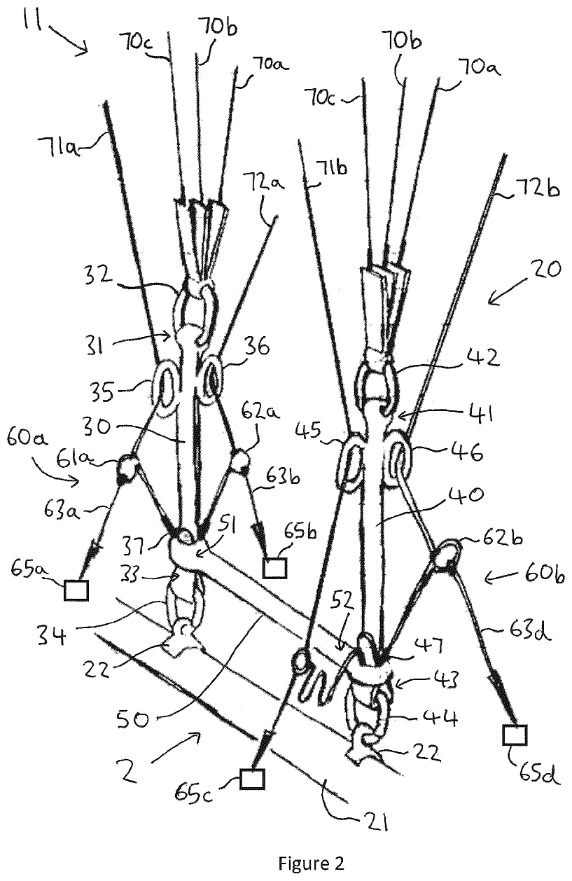

FIG. 2 illustrates a canopy attachment yoke 20 comprising first 30 and second 40 support bars. The first support bar 30 has a first end 31 and a second end 33. The second support bar 40 has a first end 41 and a second end 43.

The respective first ends 31, 41 of the first 30 and second 40 support bars are configured for attachment to at least one support line 70a, 70b, 70c of a canopy. In the embodiment shown, each of the first ends 31, 41 is provided with a ring 32, 42, to which the plurality of support lines 70a, 70b, 70c may be secured.

In FIG. 2, there are two sets of three support lines 70a, 70b, 70c shown. Each of these support lines 70a, 70b, 70c may comprise a riser. As is conventional, each riser may be connected to a plurality of main support lines which, in turn, are each connected to a plurality of gallery lines which are connected to distributed points across the canopy.

The respective second ends 33, 43 of the first 30 and second 40 support bars are configured for attachment to a vehicle 1. The vehicle 1 may comprise a mounting bar 21, to which the canopy attachment yoke 20 may be secured. A ring 34, 44 may be provided at the second ends 33, 43 of the first 30 and second 40 support bars, to connect the yoke 20 to the vehicle 1.

The rings 32, 42, 34, 44 conveniently provide a pivoting connection. The rings 32, 42, 34, 44 may be closed rings or, alternatively, they may be openable (such as a carabiner).

When the canopy attachment yoke 20 is attached to a vehicle 1, and the canopy is inflated and rotated so as to sit above the vehicle 1 (as shown in FIG. 2), the first 30 and second 40 support bars are generally arranged vertically. Consequently, the respective first ends 31, 41 may be seen as the “upper” ends and the second ends 33, 43 may be seen as the “lower” ends.

As the skilled person will appreciate, particularly during inflation and rotation of the canopy into place, the canopy attachment yoke 20 will rotate about the attachment points 22 on the mounting bar 21.

The canopy attachment yoke 20 further comprises at least one spreader bar 50 having a first end 51 and a second end 52. The first end 51 is connected to the first support bar 30 and the second end 52 is connected to the second support bar 40.

In at least one embodiment, the first 30 and second 40 support bars and the spreader bar 50 are substantially rigid. That is to say that each of the bars 30, 40, 50 substantially resists bending.

In at least one embodiment, the spreader bar 50 is rigidly secured between the first 30 and second 40 support bars. In other words, there may be a rigid intersection between the spreader bar 50 and the first 30 and second 40 support bars. Generally, as will be appreciated from FIG. 2, the first 30, second 40 support bars and the spreader bar 50 generally take the appearance of an “H” shape. The spreader bar 50 is generally perpendicular to the first 30 and second 40 support bars.

The spreader bar 50 may be slidably mounted on the first 30 and second 40 support bars. The position of the spreader bar 50 with respect to the longitudinal axes of the first 30 and second 40 support bars may be adjustable and it may be lockable in place.

In another embodiment, not shown, there may be more than one spreader bar 50, so as to provide additional strength to the canopy attachment yoke 20.

In the embodiment shown, there is a single spreader bar 50. The first end 51 of the spreader bar 50 is connected at a point between the first 31 and second 33 ends of the first support bar 30. The second end 52 of the spreader bar 50 is connected at a point between the first 41 and second 43 ends of the second support bar 40.

In the embodiment shown, the first 30 and second 40 support bars further comprise at least one eyelet 35, 36, 45, 46 for receiving a respective control line 71a, 71b, 72a, 72b therethrough, in use.

In the embodiment shown, the control lines 71a, 71b may comprise acceleration lines which, when pulled downwardly, affect the acceleration of the canopy arrangement. The other control lines may comprise brake lines 72a, 72b. When the brake lines 72a, 72b are pulled, they may serve to slow down the speed of air flow over the canopy. The use of the acceleration lines 71a, 71b and brake lines 72a, 72b are generally conventional.

The eyelets 35, 36, 45, 46 are generally arranged adjacent the first ends 31, 41 of the first 30 and second 40 support bars 40. This is not essential. They may instead be arranged away from the first ends 31, 41 of the first 30 and second 40 support bars.

The eyelet 35 may be arranged on an opposite side of the first support bar 30 to the eyelet 36. The eyelet 45 may be arranged on an opposite side of the second support bar 40 to the eyelet 46. The eyelets 35, 45 may be on a front (fore) facing side of the first 30 and second 40 support bars, and the eyelets 36, 46 may on a rear (aft) facing side of the first 30 and second 40 support bars.

The first 30 and second 40 support bars further comprise at least one anchor point 37, 47 for securement of the end of a respective control line 71a, 71b, 72a, 72b of the canopy, in use. The control lines 71a, 71b, 72a, 72b are fed through the eyelets 35, 36, 45, 46 and then secured to the respective anchor points 37, 47.

The canopy arrangement including the canopy attachment yoke 20 further comprises an actuator mechanism 60a, 60b which is operably connected to the control lines 71a, 71b, 72a, 72b, at a point between the anchor points 37, 47 and the eyelets 35, 36, 45, 46, such that operation of the actuator mechanism 60a, 60b causes the control lines 71a, 71b, 72a, 72b to selectively travel through the eyelets 35, 36, 45, 46.

Specifically, the acceleration line 71a passes through the eyelet 35 and is secured to the anchor point 37. The brake line 72a passes through the eyelet 36 and is secured to the anchor point 37. The acceleration line 71b is passed through the eyelet 45 and is secured to the anchor point 47. The brake line 72b passes through the eyelet 46 and is secured to the anchor point 37.

There may be rings 61a, 62a, 61b, 62b secured to the respective control lines 71a, 71b, 72a, 72b at a location spaced from the anchor points 37, 47. The actuator mechanism 60a, 60b may be operably connected to the rings 61a, 62a, 61b, 62b.

The anchor point 37 may be located at or adjacent the bottom 33 of the first support bar 30, and the anchor point 47 may be located at or adjacent the bottom 43 of the second support bar 40. After being secured to the rings 61a, 62a, 61b, 62b, the control lines 71a, 71b, 72a, 72b may pass through the ends 51, 52 of the spreader bar 50 before ending at anchor points 37, 47, as shown in the embodiment in FIG. 2. Sliding the spreader bar 50 up and down the support bars 30, 40 may cause the control lines 71a, 71b, 72a, 72b to be held against the support bars 30, 40 at a selective point along the length of the respective support bars 30, 40, thereby shortening or lengthening the control lines 71a, 71b, 72a, 72b.

In another embodiment, not shown, the anchor points may instead be located on the ends 51, 52 of the spreader bar 50 itself. Sliding the spreader bar 50 up or down the support bars 30, 40 directly shortens or lengthens the control lines 71a, 71b, 72a, 72b.

The actuator mechanism may comprise a servomechanism 65a, 65b, 65c, 65d and an actuator line 63a, 63b, 63c, 63d secured between the servomechanism 65a, 65b, 65c, 65d and the control line 71a, 71b, 72a, 72b. The actuator lines 63a, 63b, 63c, 63d may be secured to the respective rings 61a, 62a, 61b, 62b. This is not essential. The actuator lines 63a, 63b, 63c, 63d may be secured directly to the control lines 71a, 71b, 72a, 72b.

In FIG. 2, the actuator line 63c is shown as having been pulled, such that the acceleration line 71b is pulled through the eyelet 45, thereby affecting the acceleration of the canopy.

It will be noted that the end of the acceleration line 71b between the ring 61b and the anchor point 47 goes slack. When the actuator line 63c is released, or otherwise restored, the acceleration line 71b is allowed to pass back through the eyelet 45. When no downward force is exerted on any of the actuator lines 63a, 63b, 63c, 63d, the control line 71a, 71b, 72a, 72b are nevertheless retained on the canopy attachment yoke 20 by virtue of the anchor points 37, 47. This is different to known arrangements, where the control lines 71a, 71b, 72a, 72b are not fixed to an attachment yoke at all, but instead lead to human hand-held controls.

The position of the slidable spreader bar 50 along the length of the support bars 30, 40 may affect how the actuator lines 63a, 63b, 63c, 63d are pulled, as the control lines 71a, 72a, 71b, 72b may be shortened/lengthened, thereby affecting the acceleration/braking of the canopy.

As the canopy inflates and creates a pressurised wing, the angular position of the canopy changes. The canopy starts to rise towards a position where it is generally over the aerial vehicle 1. During the rotation phase, the length of control lines 71a, 72a, 71b, 72b may change. The spreader bar 50 may slide up or down the support bars 30, 40 to compensate for this change in the length of the control lines 71a, 72a, 71b, 72b. Adjusting the length of the control lines 71a, 72a, 71b, 72b ensures the load is distributed equally, or as needed, for flight stability and to eliminate any undesirable tilt of the aerial vehicle 1.

Different canopy attachment yoke sizes may be used for different applications of the aerial vehicle 1. The slidable spreader bar 50 may be used to adjust and calibrate the length of the control lines 71a, 72a, 71b, 72b depending on the size of the canopy attachment yoke, to eliminate any undesirable tilt of the aerial vehicle 1.

KR101862286 and KR101877800 both disclose powered paragliders with an attachment that has horizontal support bars, when in use, and a spreader bar fixed in place between the support bars. FR2408522 discloses a canopy attachment that has vertical support bars when in use, and a spreader bar fixed in place at the bottom of the support bars. In contrast to these documents, the spreader bar 50 of the present invention may be slidable up and down support bars 30, 40 that are vertical when in use. The slidable spreader bar 50 may allow the bar to be kept away from the propeller 7 more easily, and/or to compensate for any change in the length of the control lines 71a, 72a, 71b, 72b during the rotation phase of the canopy, or if a different canopy attachment yoke size is used.

A particular benefit of the present invention is that it reduces the risk of tangling of the control lines 71a, 72a, 71b, 72b. This is because the ends of the control lines are always secured in the correct places to the canopy attachment yoke 20.

In at least one embodiment, at least some of the components may be colour coded or otherwise marked so as to provide a visual indicator to a user as to how they are to be secured together. For example, all of the attachment points on the first support bar 30 may be one colour and all of the attachment points on the second support bar 40 may be another colour. Alternatively or additionally, some of the attachment points may be sized so as only to attach to a corresponding securement point.

In at least one embodiment, the axial length of the first 30 and second 40 support bars is configured such that, during the inflation and rotation phases (when the canopy attachment yoke 20 is tilted backwards), the rigid first 30 and second 40 support bars keep the canopy lines 11 away from the propeller 7, so as to prevent them being caught in the blades of the propeller. Even when a propeller guard 9 is present, it is nevertheless beneficial to avoid any unintentional tangling of the canopy lines 11 with the guard 9.

The spreader bar 50 may be arranged such that, during inflation and/or rotation, it is in front of or behind the propeller 7. The spreader bar 50 may be slidably mounted on the support bars 30, 40 to provide flexibility and make it easier to keep the spreader bar 50 away from the propeller 7, during inflation and/or rotation.

The spreader bar 50 may be slidably mounted such that its position along the support bars 30, 40 may change, due to gravity, in use as the support bars 30, are rotated. The spreader bar 50 may be slid along the support bars 30, 40 and then selectively held at a predetermined position, for example by a clamping element. The positon of the spreader bar 50 along the support bars 30, 40 may be controllable, for example by a linear actuator.

The yoke 20 may be seen as acting as a brace to keep the canopy lines 11 away from each other and/or away from the propeller 7 in use.

When used in this specification and claims, the terms “comprises” and “comprising” and variations thereof mean that the specified features, steps or integers are included. The terms are not to be interpreted to exclude the presence of other features, steps or components.

The features disclosed in the foregoing description, or the following claims, or the accompanying drawings, expressed in their specific forms or in terms of a means for performing the disclosed function, or a method or process for attaining the disclosed result, as appropriate, may, separately, or in any combination of such features, be utilised for realising the invention in diverse forms thereof.

Although certain example embodiments of the invention have been described, the scope of the appended claims is not intended to be limited solely to these embodiments. The claims are to be construed literally, purposively, and/or to encompass equivalents.

1. A canopy attachment yoke, comprising:
first and second support bars, each having a first end and a second end, wherein the respective first ends are configured for attachment to at least one support line of a canopy and the respective second ends are configured for attachment to a vehicle; and
at least one spreader bar having a first end and a second end, the first end of the spreader bar connected to the first support bar and the second end of the spreader bar connected to the second support bar, wherein the spreader bar is slidably mounted on the first and second support bars.

2. A canopy attachment yoke according to claim 1, wherein the first and second support bars and the at least one spreader bar are substantially rigid.

3. A canopy attachment yoke according to claim 1, wherein the at least one spreader bar is rigidly secured between the first and second support bars.

4. A canopy attachment yoke according to claim 1, comprising a single spreader bar, wherein the first end of the spreader bar is connected at a point between the first and second ends of the first support bar and the second end of the spreader bar is connected at a point between the first and second ends of the second support bar.

5. A canopy attachment yoke according to claim 1, wherein the first and second support bars further comprise at least one eyelet for receiving a respective control line of the canopy therethrough, in use.

6. A canopy attachment yoke according to claim 1, wherein the first and second support bars further comprise at least one anchor point for securement of the end of a respective control line of the canopy, in use.

7. A canopy arrangement comprising:
a canopy, comprising a plurality of support lines and at least one control line; and
a canopy attachment yoke according to claim 1, connected to the support lines of the canopy.

8. A canopy arrangement according to claim 7, wherein the canopy attachment yoke comprises at least one eyelet at or adjacent the first end of each support bar, and an anchor point at or adjacent the second end of each support bar,
wherein the at least one control line is fed through said eyelet and secured to said anchor point.

9. A canopy arrangement according to claim 8, further comprising an actuator mechanism operably connected to the control line at a point between the anchor point and the eyelet, wherein operation of the actuator mechanism causes the control line to travel through the eyelet.

10. A canopy arrangement according to claim 9, wherein the actuator mechanism comprises a servomechanism and an actuator line secured between the servomechanism and the control line.

11. An aerial vehicle comprising:
an airframe; and
a canopy arrangement according to claim 7, wherein the canopy attachment yoke is removably attached to the airframe.
